(19) United States
(12) Patent Application Publication
(10) Pub. No.: US 2007/0042626 A1
(43) Pub. Date: Feb. 22, 2007

(54) Multi-port jack assembly

(75) Inventor: Ting-Yin Chiu, Taichung City (TW)

Correspondence Address: BACON & THOMAS, PLLC, 625 SLATERS LANE, FOURTH FLOOR, ALEXANDRIA, VA, 22314, US

(73) Assignee: INFINITE ELECTRONICS INC., TAICHUNG CITY (TW)

(21) Appl. No.: 11/205,066

(22) Filed: Aug. 17, 2005

(51) Int. Cl. H01R 4/60

(52) U.S. Cl. 439/214

(57) ABSTRACT

A multi-port jack assembly adapted for power transformers for computers includes a main body. The main body has a plurality of convex connection ports for electrical connection with the power transformers, an electric wire electrically connected with an end of the main body, and a plug electrically connected with a distal end of the electric wire. Thus, the present invention is connectable with the multiple transformers adapted for the computers to enable one-to-multiplicity connection and to further reduce the number of the electric wires.

### BACKGROUND OF THE INVENTION

1. Field of the Invention

The present invention relates generally to jack assembly, and more particularly, to a multi-port jack assembly adapted for power transformers for computers.

2. Description of the Related Art

As we are aware, while operating a computer, especially a notebook computer, a common user usually has to connect the notebook computer to a transformer and then connect the transformer to an electric receptacle for supplying stable voltage to the notebook computer for normal operation.

However, while several notebook computers are operated in the same position at the same time, it is necessary to connect several transformers and several electric wires exclusively for the transformers for supplying each notebook computer with a predetermined stable voltage. As the wires and transformers are increased in number, the wires are subject to entanglement with one another to incur defective heat dissipation and the transformers are hardly space-saving, thus requiring further improvement.

### SUMMARY OF THE INVENTION

The primary objective of the present invention is to provide a multi-port jack assembly, which is adapted for electrical connection with a plurality of transformers for a plurality of computers.

The foregoing objective of the present invention is attained by the multi-port jack assembly, which includes a main body. The main body has a plurality of convex connection ports for electrical connection with power transformers adapted for computers, an electric wire electrically connected with an end of the main body, and a plug electrically connected to a distal end of the electric wire. Thus, the present invention is connectable with the multiple transformers adapted for the computers to enable one-to-multiplicity connection and to further reduce the number of the electric wires.

### BRIEF DESCRIPTION OF THE DRAWINGS

FIG. 1 is a perspective view of a preferred embodiment of the present invention.

FIG. 2 is a schematic view of a corresponding dual-jack coupling end of a power transformer to a connection port of the main body in accordance with the preferred embodiment of the present invention.

FIG. 3 is a perspective view of the preferred embodiment of the present invention in operation with the power transformer.

FIG. 4 is similar to FIG. 2, showing a triple-jack coupling end of the transformer.

FIG. 5 is similar to FIG. 4, showing another type of the coupling end of the transformer.

FIG. 6 is similar to FIG. 4, showing another type of the coupling end of the transformer.

### DETAILED DESCRIPTION OF PREFERRED EMBODIMENTS

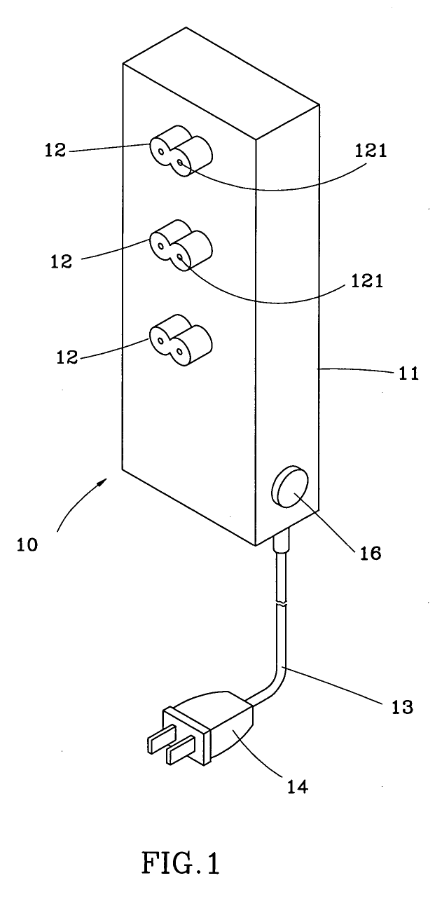

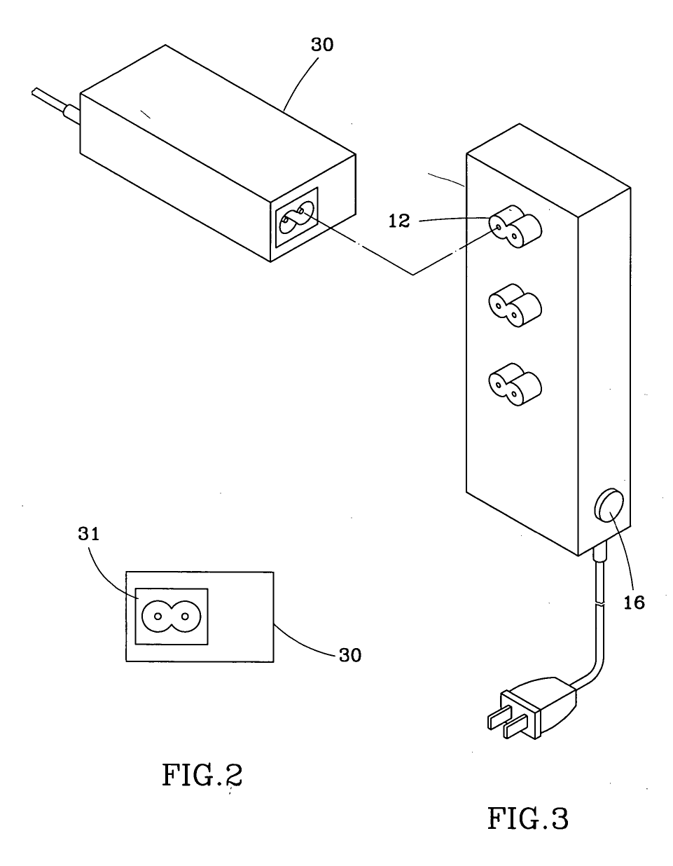

Referring to FIGS. 1 and 2, a multi-port jack assembly 10 adapted for power transformers for computers, constructed according to a preferred embodiment of the present invention is composed of a main body 11, a plurality of connection ports 12, an electric wire 13, and a plug 14.

The main body 11 is shaped like a rectangular parallelepiped. The connection ports 12 are formed on a side of the main body 11 and each two adjacent ones are spaced from each other in a predetermined distance. Each of the connection ports 12 has a corresponding shape to a coupling end 31 of a transformer 30 for a computer to be convex. In this embodiment, each of the connection ports 12 is dual-jack to have two jacks, which have two cavities 121 formed respectively therein. Two electrically conductive pins (not shown) are mounted respectively in the two cavities 121. The electric wire 13 is connected with an end of the main body 11, having a distal end connected with a plug 14.

While the multi-port jack assembly 10 is in use, the user can insert the plug 14 into a household mains receptacle and then insert the transformers 30 into one of the connection ports 12. As shown in FIG. 3, one transformer 30 is plugged into one connection port 12. In fact, a plurality of the transformers 30 can be plugged respectively into the connection ports 12 at the same time.

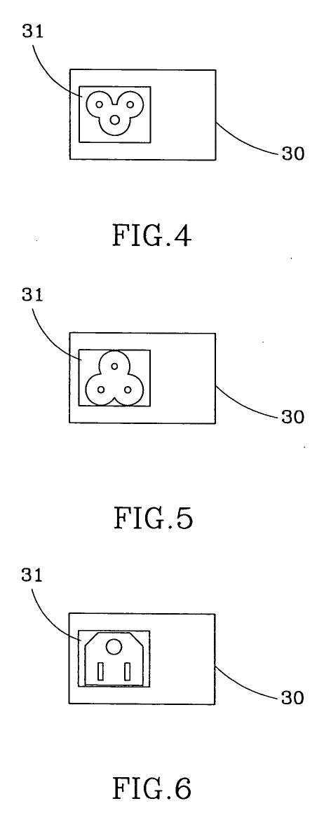

The coupling end 31 of the transformer 30 can alternatively be triple-jack. Referring to FIGS. 4-6, each of the connection ports 12 can also alternatively be formed in corresponding shape to the coupling end 31. FIGS. 2 and 4-6 show multiple types of the connection port 12. The coupling end 31 can also alternatively be variously formed in corresponding shape to the connection port 12 for compatible connection with each other.

Referring to FIGS. 1 and 3, the multi-port jack assembly 10 can alternatively further include an over-current protection reset button 16 mounted at a side of the main body 11 and electrically connected with the connection ports 12 for over-current protection and reset of operation.

It is to be noted that the connection port 12 and the coupling end 31 are interchangeable in convex and concave shape for perfect interconnection.

What is claimed is:

1. A multi-port jack assembly adapted for power transformers for computers, comprising a main body, a plurality of convex connection ports formed on said main body for connection with said power transformers, an electric wire electrically connected with an end of said main body, and a plug electrically connected with a distal end of said electric wire.

2. The multi-port jack assembly as defined in claim 1, wherein said connection ports are dual-jack to have two jacks, each of said two jacks having a cavity and an electrically conductive pin mounted in each of said two cavities.

3. The multi-port jack assembly as defined in claim 1, wherein said connection ports are triple-jack to have three jacks, each of said three jacks having a cavity and an electrically conductive pin mounted in each of said three cavities.

4. The multi-port jack assembly as defined in claim 1 further comprising an over-current protection reset button, said over-current protection reset button being mounted at a side of said main body and electrically connected with said connection ports for over-current protection and reset of operation.
